(19) United States
(12) Patent Application Publication
(10) Pub. No.: US 2003/0116547 A1
(43) Pub. Date: Jun. 26, 2003

(54) Passive alignment of optoelectronic components using laser-heating technology

(76) Inventors: Young Bok Choi, Seongnam-si (KR); Soo Jin Park, Seongnam-si (KR); Ki Tae Jeong, Seongnam-si (KR); Tae Sang Park, Seongnam-si (KR)

Correspondence Address: PENNIE & EDMONDS LLP, 1667 K STREET NW, SUITE 1000, WASHINGTON, DC, 20006

(21) Appl. No.: 10/327,989

(22) Filed: Dec. 26, 2002

(30) Foreign Application Priority Data
Dec. 26, 2001 (KR) 2001-85004

(51) Int. Cl. B23K 1/005

(52) U.S. Cl. 219/121.85

(57) ABSTRACT

A plurality of solder layers are disposed on a substrate and an optical component is aligned on each of the solder layer. Laser beams are applied to a corresponding section of the substrate to heat a first solder layer on which a first optical component is positioned. Then, the first solder layer is cooled so that the first optical component is bonded to the substrate. Subsequently, laser beams are applied to a second solder layer to bond a second optical component thereon to the substrate.

### FIELD OF THE INVENTION

The present invention relates to a method for aligning optoelectronic or optical components on a substrate; and, more particularly, to a passive alignment of optoelectronic or optical components using a laser-heating technology.

### BACKGROUND OF THE INVENTION

Recent developments in optical communication systems have given rise to miniaturized optical devices that include very small optoelectronic or optical components, most of which must be aligned to micron-scale tolerances. The alignment of optical components such as laser diodes (LD) or photo diodes (PD) is generally performed in one of two ways: passive alignment or active alignment.

The active alignment technique is to find an optimum position where an optical component can show the maximum performance. Therefore, a target component should be turned on during the alignment process to check the performance thereof. Such an active alignment technique can provide an optimum alignment of the optical components but is time consuming and labor intensive, which adds to the cost of the optical package. Furthermore the time and labor needed limit high volume production of optical components.

Instead of finding the optimum position of each optical component, the passive alignment technology is to align the optical components on preset positions to micron-scale tolerances using a high precision instrument. Since the position of each component is predetermined and adjustments thereof are not performed during the alignment process, the passive alignment technology is better for use in high volume production of the optical components at low cost.

The passive alignment technology is performed in one of various ways: a mechanical alignment, a flip-chip bonding, or a marking alignment.

In the mechanical alignment, a number of device pits and/or grooves are formed in a mounting block on which the optical components are to be supported. The size and position of the device pits and grooves are predetermined according to the specific optical components and the desired alignment configuration such that the optical components, when mounted and fixed in the appropriate device pits and grooves, will automatically be in their aligned positions. The mechanical alignment has a drawback of requiring very high accuracy, e.g., micron-scale tolerances, for placement.

The flip-chip bonding is a method using a surface tension of solder, wherein solder pads are formed on an optical component such as a waveguide by using a photolithographic process and a solder layer is disposed on the solder pad by using a mask. After the mask is removed, the solder is heated above its melting point to re-flow into a molten solder bump, which is then allowed to cool, wherein surface tension of the solder bump acts to pull the pads into substantial optical alignment with other optical or optoelectronic components. This method has some drawbacks in that the formation of solder pads and solder bump is difficult and oxidation of the solder should be avoided.

The marking alignment is to form aligning patterns on each of a substrate and optical components. By using the patterns, the optical components can be accurately aligned on the substrate.

Referring to FIG. 1, one of the aforementioned methods for passively aligning optical components by using a conventional heating technology will be explained together with drawbacks thereof.

After a multiplicity of solder layers 4 are disposed on a substrate 2, a multiplicity of laser chips 1 are respectively mounted at desired locations over the substrate 2 with the solders 4 interposed therebetween. Positioned under the substrate 2 is a heater 3 for heating the solder layers 4 to a molten solder bump, which is then cooled to bond the optical components 1 on the substrate 2.

The aforementioned soldering or heating technology has no problem in bonding simply one of the optical components on the substrate. However, when a multiplicity of optical components that will be bonded on the substrate are concerned, a problem may occur in that some of the optical components are misaligned with respect to others because all of the solder layers 4 are simultaneously heated into a liquid phase. Further, a different kind of components that are already fixed on the substrate by means of soldering may be displaced because of the wide range heating.

### SUMMARY OF THE INVENTION

It is, therefore, an object of the present invention to provide a passive alignment method using a local laser-heating technology, so that misalignment of optical components is prevented.

In accordance with the preferred embodiment of the invention, there is provided a method of aligning a plurality of optical components on a substrate, the method including the steps of: preparing a substrate; forming a plurality of solder layers on the substrate; aligning a plurality of optical components on the plurality of solder layers, respectively; radiating laser beams onto a corresponding section of the substrate to heat a first solder layer to a liquid phase, the first solder layer being then cooled so that a first optical component disposed on the first solder layer is bonded to the substrate; and radiating laser beams onto another corresponding section of the substrate to heat a second solder layer to a liquid phase, the second solder layer being then cooled so that a second optical component disposed on the second solder layer is bonded to the substrate.

### BRIEF DESCRIPTION OF THE DRAWINGS

The above and other objects and features of the present invention will become apparent from the following description of a preferred embodiment given in conjunction with the accompanying drawings, in which:

FIG. 1 is a cross-sectional view illustrating a passive alignment method using a heater; and

FIG. 2 provides a cross-sectional view illustrating a passive alignment method using a laser-heating technology in accordance with the preferred embodiment of the present invention.

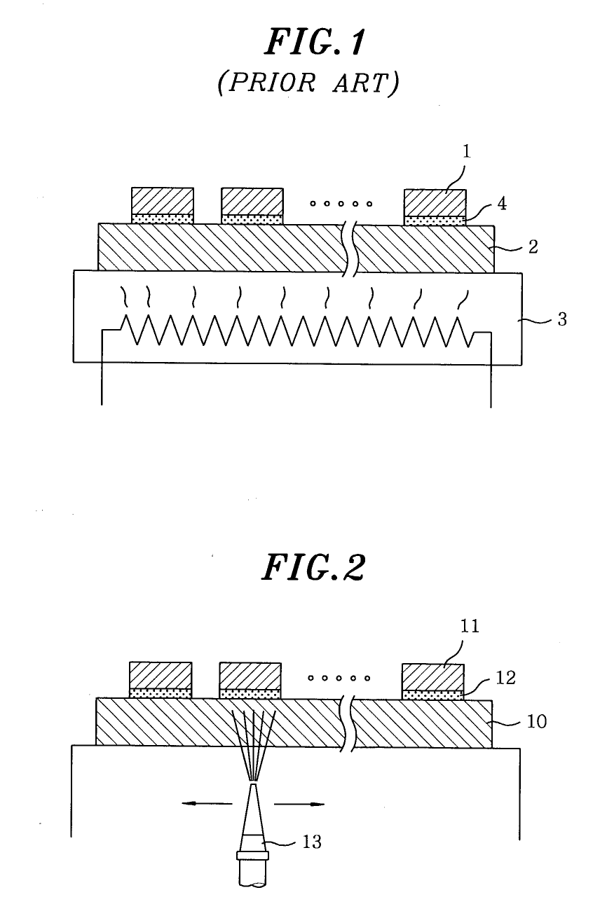

### DETAILED DESCRIPTION OF THE PREFERRED EMBODIMENT

Referring now to FIG. 2, a passive alignment method using a laser-heating technology in accordance with the preferred embodiment of the present invention will be described in detail.

In FIG. 2, a substrate 10 is shown; a laser heater 13 employing CO₂ laser or Nd:YAG laser is movably located thereunder. Respectively disposed at predetermined positions on the substrate 10 are an array of solder layers 12, on which an array of optical or optoelectronic components are respectively aligned. The laser heater 13 severs to apply heat to a desired section of the substrate 10 such that a corresponding solder layers 12 can be heated to re-flow into a molten solder bump, which is then cooled. By this way, each of the optical components 11 is bonded to the substrate 10 via a corresponding solder layer 12.

When a laser is used for heating an object, laser beams are focused on a spot of a surface of the object by using a mirror or a lens. The laser-focused spot of the surface is heated into a molten or a vaporized phase. Since heat is diffused from the laser-focused spot with a Gaussian variation, controlling the power of the laser makes it possible to obtain a desired temperature at a desired location of the object.

Each of CO₂ laser and Nd:Yag laser has a capability to be pulsed or continuously fired. In an equal mode of beams based on the wavelength thereof, Nd:Yag laser is ten times superior to Co₂ laser in a size and a depth of a focal point of the beams. Therefore, Nd:Yag laser is usually used for a high precision machining. In comparison, CO₂ laser shows a superior beam quality and can be used for a machining at a power of a few watts to hundreds of kilowatts.

In the alignment method using the laser-heating technology in accordance with the preferred embodiment, to bond a target optical component to the substrate 10, only a corresponding solder layer except the others is heated to a liquid phase by the laser heater 13 that can apply heat to a desired section of the substrate 10 without affecting the other sections thereof. Since the heat applied for bonding the target optical component rarely affects the other solder layers, previously bonded optical components are prevented from being adversely displaced during the heating. That is to say, the laser-heating technology in accordance with the present invention rarely affects the alignment of the optical component already bonded on the substrate 10.

After the present optical component is bonded on the substrate 10, the laser heater 13 is moved to heat a next solder layer that corresponds to a next target optical component. By repeating the aforementioned local heating and cooling, a multiplicity of optical components 11 can be bonded on the substrate 10 with much reduced misalignments.

While the invention has been shown and described with respect to the preferred embodiments, it will be understood by those skilled in the art that various changes and modifications may be made without departing from the spirit and scope of the invention as defined in the following claims.

What is claimed is:

1. A method of aligning a plurality of optical components on a substrate, comprising the steps of:
preparing a substrate;
forming a plurality of solder layers on the substrate;
aligning a plurality of optical components on the plurality of solder layers, respectively;
radiating laser beams onto a corresponding section of the substrate to heat a first solder layer to a liquid phase, the first solder layer being then cooled so that a first optical component disposed on the first solder layer is bonded to the substrate; and
radiating laser beams onto another corresponding section of the substrate to heat a second solder layer to a liquid phase, the second solder layer being then cooled so that a second optical component disposed on the second solder layer is bonded to the substrate.

2. The method of claim 1, wherein Nd:YAG laser is used for the laser beams.

3. The method of claim 1, wherein CO₂ laser is used for the laser beams.
